(19) United States
(12) Patent Application Publication
(10) Pub. No.: US 2004/0134330 A1
(43) Pub. Date: Jul. 15, 2004

(54) Guitar bridge having tone and volume controls

(76) Inventors: Michael Frank Braun, Corona, CA (US); Daniel Smith, Corona, CA (US)

Correspondence Address: STRADLING YOCCA CARLSON & RAUTH, Suite 1600, 660 Newport Center Drive, Newport Beach, CA, 92660-1600, US

(21) Appl. No.: 10/345,611

(22) Filed: Jan. 15, 2003

(51) Int. Cl. G10D 3/04

(52) U.S. Cl. 84/298

(57) ABSTRACT

A bridge assembly for a musical instrument, such an electric guitar, an acoustic-electric guitar, or a semi-acoustic guitar has a bridge and at least one electrical control formed to the bridge. The electrical control(s) control at least one electrical parameter of the musical instrument. For example, the tone and volume controls of an electric guitar may be formed to the bridge of the electric guitar.

### FIELD OF THE INVENTION

The present invention relates generally to stringed electric musical instruments. The present invention relates more particularly to a bridge assembly for a stringed musical instrument, such as an electric guitar, an acoustic-electric guitar, or a semi-acoustic guitar wherein the bridge assembly comprises a bridge and at least one electrical control formed to the bridge for controlling at least one electrical parameter of the musical instrument.

### BACKGROUND OF THE INVENTION

Stringed musical instruments, such as electric guitars, are well known. Such stringed musical instruments typically have a body (which may be either solid or hollow) and a neck attached to the body. Strings extend from a distal end of the neck to the body. Typically, the strings are supported at the neck by a nut and are supported at the body by a bridge. On some instruments, the strings terminate at the bridge. On other instruments, the strings pass over the bridge and terminate at a tail piece.

Some bridges are configured so as to facilitate intonation compensation. As those skilled in the art will appreciate, the intonation of a stringed musical instrument is determined by that portion of the length of each string which is free to vibrate with picked. Due to inherent variations in the physical properties of the strings (such as their weight distribution and their flexibility), each string of a musical instrument will not necessarily have the same length when proper intonation is achieved. The length of that portion of a string which is free to vibrate is typically determined, in part, by the position of a saddle. The saddle is attached to the bridge and contacts the string so as to provide support therefor.

By positioning and orienting the saddle or saddles of a bridge appropriately, intonation compensation for the musical instrument can be provided. On some musical instruments intonation is improved by orienting a single saddle (which supports all six strings of a guitar, for example) such that the strings have approximately the necessary different lengths. On some musical instruments, separate saddles are provided for each string, such that the intonation of each string can be individually adjusted or compensated for by the position of the saddles.

Typically, electric musical instruments, such as electric guitars, also have controls built into the body thereof for facilitating adjustment of the tone and volume of the musical instrument. These controls are usually potentiometers which vary electrical parameters of circuitry associated with the pickup or pickups of the electric musical instrument. Generally, the tone control comprises a potentiometer which adjusts the amount of the high frequencies from a pickup or pickups which is shunted through a capacitor and thus is substantially attenuated or removed from the output signal of the electric musical instrument. Generally, the volume control comprises a potentiometer which functions as a voltage divider to define that portion of the voltage output of the pickup or pickups which is provided as the output signal of the electric musical instrument, thus determining the strength of the output signal.

Typically, each potentiometer will have a knob attached thereto. The potentiometer is typically located within the body of the electric musical instrument and the knob is typically located outside of the body of the electric musical instrument.

Although such body-mounted tone and volume controls are generally suitable for their intended purposes, such contemporary body-mounted tone and volume controls do suffer from inherent deficiencies which detract from their overall usefulness and desirability. For example, contemporary tone and volume controls are positioned on the body of a guitar in locations where the knobs thereof are likely to be inadvertently manipulated by a guitar player during the performance of a song. As those skilled in the art will appreciate, such inadvertent manipulation of either the tone or volume control is likely to result in an undesirable change in the signal output from the electric guitar and thus consequently result in an undesirable change in the sound of the song being performed.

Inadvertently manipulating the tone control will necessarily result in a change in the tone of the musical instrument. This may result in the sound of the guitar, for example, being either undesirably too bright (too much high frequency) or undesirably too muddy (too much low frequency). In either instance, the performance may be ruined.

Similarly, inadvertently manipulating the volume control will necessarily result in a change in the volume of the musical instrument. This may result in the sound of the guitar being either undesirably too loud or undesirably too quiet during a performance. In either instance, the performance may be ruined.

The ruined performance of a song may have serious negative consequences during live performances, wherein an audience has certain expectations regarding the quality of the performance and has paid to have these expectations met. The ruined performance of a song during a recording session necessitates that the song be repeated, thus incurring additional costs related to studio time and attending technical personnel. In either instance, it is by far preferred that no performances be ruined due to the inadvertent manipulation of the tone and/or volume controls of a musical instrument.

Furthermore, placement of the tone and volume controls of a musical instrument upon the body of the musical instrument such that the tone and volume controls define prominent, readily observed features of the musical instrument, may be undesirable. In some instances, it may be aesthetically preferable to not have the tone and volume controls conspicuously mounted upon the body of the musical instrument. Not mounting the tone and volume controls on the body of the musical instrument provides a cleaner, arguably more aesthetically pleasing look.

Mounting the volume and tone controls to the top or soundboard of an acoustic-electric guitar or a semi-electric guitar inherently changes the acoustic qualities of the soundboard. For example, holes generally have to be formed in the soundboard to accomodate the mounting of volume and tone controls. Generally, such changes to the acoustic qualities of the soundboard are undesirable. Therefore, it is desirable to mount the tone and volume controls where they do not substantially change the acoustic qualities of the soundboard.

However, it is important that the tone and volume controls be readily adjustable, in the event that such adjustment is desired. This is particularly important if such adjustment is desired during the performance of a song. Therefore, the tone and volume controls must be located where the musical instrument player can easily reach them and quickly and accurately manipulate them.

In view of the foregoing, it is desirable to provide mounting of the tone and volume controls of a musical instrument, such as a guitar, such that the tone and volume controls are not likely to be inadvertently manipulated, such that they can easily be intentionally manipulated, and such that they do not form prominent or aesthetically undesirable features of the body of the musical instrument.

### SUMMARY OF THE INVENTION

The present invention specifically addresses and alleviates the above-mentioned deficiencies associated with the prior art. More particularly, the present invention comprises a bridge assembly for a musical instrument, such as an electric guitar, an acoustic guitar, or a semi-acoustic guitar, wherein the bridge assembly comprises a bridge and at least one electrical control formed to the bridge for controlling at least one electrical parameter of the musical instrument. For example, the tone and volume controls of an electric guitar may be formed to the bridge of the electric guitar.

These, as well as other advantages of the present invention, will be more apparent from the following description and drawings. It is understood that changes in the specific structures shown and described may be made within the scope of the claims without departing from the spirit of the invention.

### BRIEF DESCRIPTION OF THE DRAWINGS

FIG. 1 is a semi-schematic top view of a guitar bridge assembly having integral tone and volume controls, according to the present invention;

FIG. 2 is a semi-schematic side view of the guitar bridge assembly of FIG. 1;

FIG. 3 is a semi-schematic top view of the guitar bridge assembly of FIG. 1, showing the tone and volume control knobs removed;

FIG. 4 is a semi-schematic side view of the guitar bridge assembly of FIG. 3;

FIG. 5 is a semi-schematic exploded side view of the guitar bridge assembly of FIG. 2, showing the tone and volume control knobs, potentiometers, mounting hardware, saddles and piezoelectric sensors exploded away from the bridge assembly;

FIG. 6 is a semi-schematic side view of a representative knob, potentiometer, and mounting hardware of FIG. 2, showing the knob in cross-section;

FIG. 7 is a front view of an electric guitar having a bridge assembly with integrated tone and volume controls, according to the present invention; and

FIG. 8 is a semi-schematic side view of the guitar bridge assembly of FIG. 1, showing a printed circuit board mounted to the potentiometers thereof.

### DETAILED DESCRIPTION OF THE INVENTION

The detailed description set forth below in connection with the appended drawings is intended as a description of the presently preferred embodiment of the invention and is not intended to represent the only form in which the present invention may be constructed or utilized. The description sets forth the functions of the invention and the sequence of steps for constructing and operating the invention in connection with the illustrated embodiment. It is to be understood, however, that the same or equivalent functions and sequences may be accomplished by different embodiments that are also intended to be encompassed within the spirit and scope of the invention.

As discussed in detail below, the present invention comprises a bridge assembly for an electric, acoustic-electric, or semi-acoustic musical instrument, wherein the bridge assembly comprises a bridge and at least one, preferably two, electrical controls formed to the bridge for controlling at least one, preferably two, electrical parameters of the musical instrument. According to the exemplary embodiment of the present invention described herein, the bridge is configured for use with an electric guitar. However, as those skilled in the art will appreciate, the bridge assembly of the present invention may alternatively be used within any other desired stringed electric musical instrument, such as an electric bass, banjo, mandolin, Dobro, or violin.

The two electrical controls preferably comprise a tone control and a volume control. The two electrical controls are preferably disposed proximate the two opposite ends of the bridge. However, the two electrical controls may alternatively be disposed at any other desired location upon the bridge.

The two electrical controls preferably comprise two rotary switches, such as potentiometers. Those skilled in the art will appreciate that other types of rotary switches, such as rotary selector switches (wherein electrical contacts are selectively made or broken), rheostats, variable capacitors and/or variable inductors may alternatively be utilized. Alternatively, other types of switches, such as pushbutton switches and touchpads, may be utilized.

Thus, according to the preferred embodiment of the present invention, the present invention comprises a potentiometer and a knob formed to the shaft of the potentiometer. Preferably, the knob is located atop, within, or some combination of atop and within, the bridge. Preferably, the potentiometer is located below the bridge, preferably within the body of the musical instrument to which the bridge is attached. Preferably, a locknut or a spacer is used to position the bodies of the potentiometers such that they do not touch the body of the musical instrument. Alternatively, the potentiometer or other type of switch may be located upon, within, or immediately below the bridge. The potentiometer or other type of switch may be located either within the body of the musical instrument or not within the body of the musical instrument.

Preferably, the bridge comprises at least one recess and the knobs of the electrical controls are disposed within their recesse(s). Preferably, the knobs extend out of the top of the recesse(s) and/or extend out of at least one side of the recesse(s).

According to the preferred embodiment of the present invention, the bridge is configured to facilitate intonation compensation for at least one string, preferably for all of the strings of the musical instrument. According to one aspect of the present invention, the bridge comprises three saddle sections, wherein each saddle section is configured to support two strings. Each of the three saddle sections is preferably independently positioned and oriented, generally at angles with respect to one another, so as to provide proper intonation. The bridge may be configured so as to facilitate intonation adjustment by movement of the bridge as a whole (thus, generally affecting all of the strings simultaneously), so as to facilitate intonation adjustment of any desired string or group of strings, or the bridge may be configured so as to not facilitate intonation adjustment.

Preferably, the bridge further comprises three or six vibration sensors, such as piezoelectric vibration sensors, wherein one vibration sensor is disposed beneath each saddle section. Alternatively, the bridge may contain any other type or number of pickup or vibration sensor or may contain no pickup or vibration sensor.

By using three saddle sections, wherein each saddle section is configured to support only two adjacent strings, it is possible to apply generally even pressure to the three piezoelectric vibration sensors by the saddle sections. Adjacent strings on a musical instrument, such as a guitar, generally vary only slightly in tension with respect to one another. By way of contrast, the tension of non-adjacent strings, such as the first and sixth strings of a guitar, vary much more with respect to one another. Since adjacent strings are generally under approximately the same amount of tension, they apply generally the same amount of pressure to the saddle. Thus, when only two strings are supported by each saddle section, each string tends to urge one end of the saddle section downwardly with approximately the same amount of force. Thus, pressure tends to be applied to the piezoelectric vibration sensors more evenly than when more than two strings are supported by a bridge section and the tension of the string at one end of a bridge section is generally substantially different from the tension of the string at the other end of the bridge section.

The use of three separate saddles provides the opportunity to control the response of each string pair of each individual saddle so as to enhance overall desired tonality performance.

As those skilled in the art will appreciate, the frequency response of a piezoelectric sensor tends to vary substantially, depending upon the pressure applied to the piezoelectric sensor. By applying the generally even pressure of adjacent pairs of strings, the frequency response for those adjacent pairs of strings tends to be approximately the same. In this manner, enhanced frequency and output response of the musical instrument is provided.

Preferably, the string holes, where the strings are anchored on the soundboard, are located at distances from the saddles which tend to provide approximately equal pressure to the piezoelectric sensors. As those skilled in the art will appreciate, the pressure applied by each string to a piezoelectric sensor depends upon the angle of the string with respect to the saddle and this angle is determined by the distance between the saddle and the hole. In this manner, differences in string tension caused by the use of strings having different diameters can be compensated for.

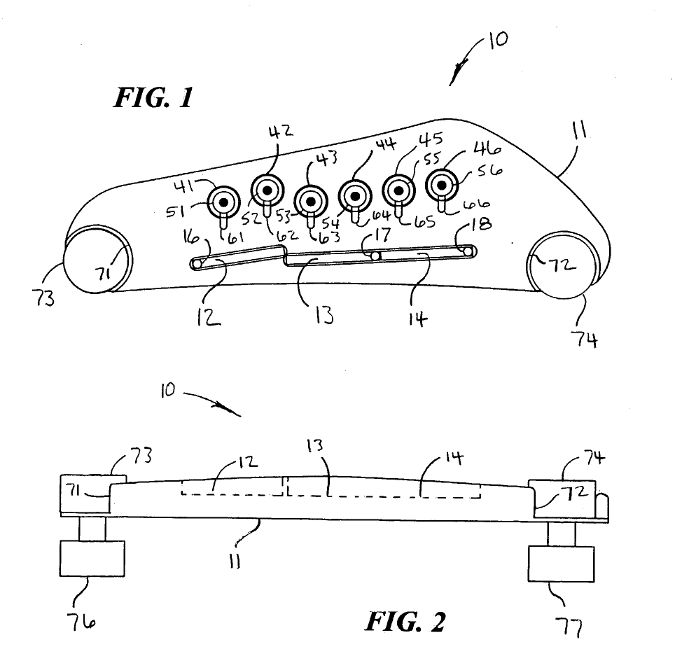

The bridge assembly for an electric musical instrument of the present invention is illustrated in FIGS. 1-7 and is discussed in further detail below.

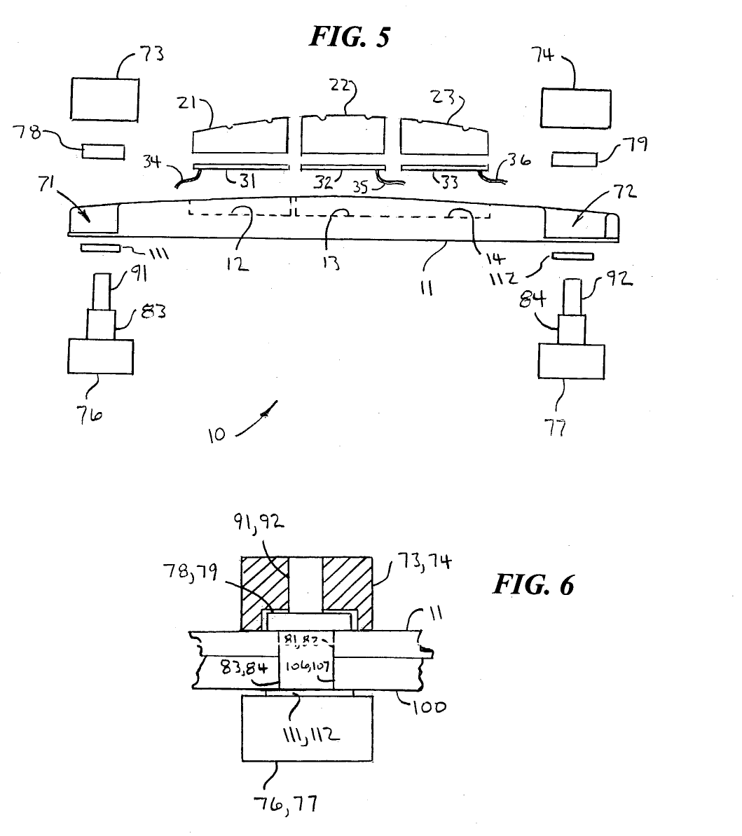

Referring now to FIGS. 1 and 2, the bridge assembly 10 comprises a bridge body 11 having at least one, preferably three saddle grooves 12, 13 and 14 into which separate saddles sections 21, 22 and 23 (FIG. 5) and piezoelectric sensors 31, 32 and 33 (FIG. 5) are received. Bores 16, 17 and 18 extend through the bridge body 11 and facilitate passage of the wires or electrical leads 34, 35 and 36 (FIG. 5) from the piezoelectric sensors 31, 32 and 33 through the bridge body 11, typically into the body of the musical instrument upon which the bridge assembly 10 is mounted.

Holes 41-46 (and typically corresponding holes in the body soundboard of the musical instrument, as well) facilitate attachment of the strings to the body of a musical instrument, such as a guitar, via pegs 51-56, according to well-known principles. Thus, slots 61-66 receive the strings, and beads or other enlarged portions formed at one end of the strings cooperate with the pegs 51-56 to anchor the strings.

The three saddle slots 12, 13 and 14 are preferably angled, so as to provide desired intonation compensation. Preferably, grooves 13 and 14 define a contiguous slot. That is, preferably saddle grooves 13 and 14 are co-linear with respect to one another and may, indeed, form a single elongate slot. This configuration of the saddle is common on acoustic guitars.

According to the preferred embodiment of the present invention, cutouts 71 and 72 are formed at opposite ends of the bridge assembly 10 and are configured so as to receive knobs 73 and 74. Preferably, the cutouts 71 and 72 are configured such that a portion of each knob 73 and 74 extends slightly above the bridge body 11, as shown in FIG. 2. Configuring the cutouts 71 and 72 such that the knobs 73 and 74 extend upwardly therefrom and slightly higher than the bridge body 11 facilitates easy rotation of the knobs by manually contacting the knobs 73 and 74 from above.

Preferably, the cutouts 71 and 72 are formed such that the knobs 73 and 74 extend sideways outside of the cutouts 71 and 72, also as shown in FIGS. 1 and 2. Configuring the cutouts 71 and 72 such that the knobs 73 and 74 extend from the sides thereof facilitates easy rotation of the knob 73 and 74 by manually contacting the sides of the knobs 73 and 74. Thus, sufficient access to the knobs 73 and 74, both at the top and sides thereof, is provided so as to facilitate easy and convenient control of the tone and volume, for example, of the musical instrument.

With particular reference to FIG. 2, potentiometers 76 and 77 are attached to the bridge body 11, preferably via attachment nuts 78 and 79, as shown in FIGS. 5 and 6 and as discussed in detail below. Thus, rotating the knobs 73 and 74 causes corresponding rotation of the shafts 91 and 92 (FIG. 5) of the potentiometer 76 and 77, respectively. In this manner, the tone and volume, for example, of the musical instrument may easily varied.

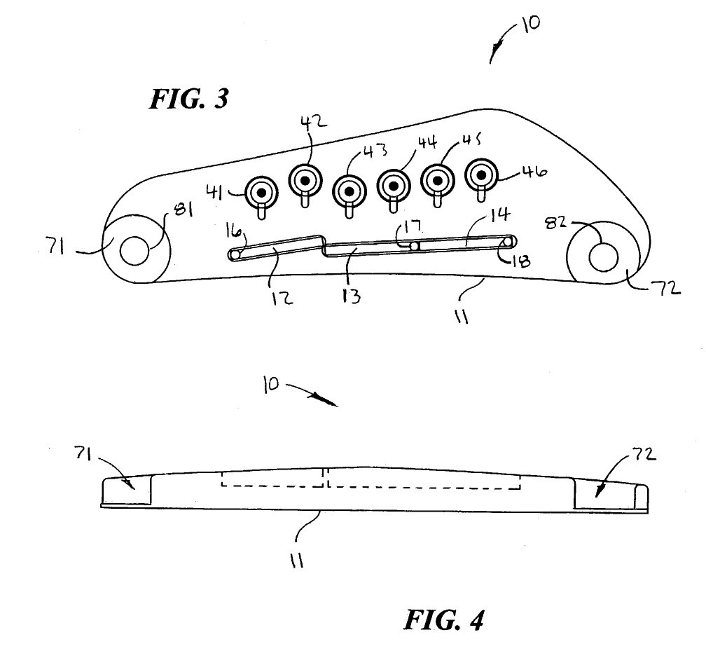

Referring now to FIGS. 3 and 4, the bridge assembly 10 of the present invention is shown with the knobs 73 and 74 and the potentiometers 76 and 77 removed therefrom, so as to better show the cutouts 71 and 72. Each cutout 71 and 72 has a bore 81 and 82, respectively, formed through the lowermost portion (defined by the bridge body 11) thereof. Each bore 81 and 82 is configured to receive the threaded posts 83 and 84 of the potentiometers 76 and 77. Thus, the bores 81 and 82 have a diameter which is slightly larger than the outer diameter of the posts 83 and 84 of the potentiometers 76 and 77, respectively.

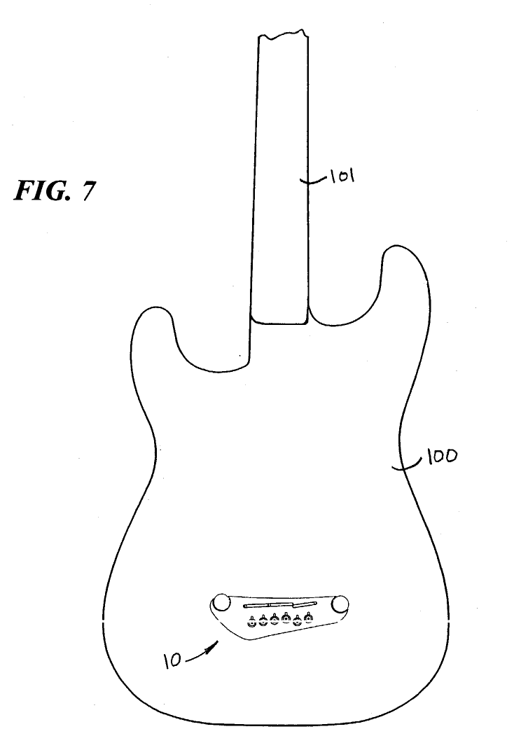

Referring now to FIG. 5, the potentiometers 76 and 77, knobs 73 and 74, saddles 21, 22 and 23, and the piezoelectric sensors 31, 32 and 33 are shown exploded away from the bridge body 11 to better illustrate the construction of the bridge assembly 10 of the present invention. As discussed in detail with reference to FIG. 6 below, the potentiometers 76 and 77 are attached through the body 100 (FIG. 7) of the guitar to the bridge body 11 by passing the posts 83 and 84 through holes 106 and 107 (FIG. 6) in the body of the guitar and through the bores 81 and 82 of the bridge body 11 and then attaching the attachment nuts 78 and 79 to the threaded posts 83 and 84. Preferably, the body of potentiometer 76 is spaced (such as via spacers or locknuts 111 and 112) away from the body of the guitar 100 (best shown in FIG. 6), such that the body of each potentiometer 76, 77 does not each touch the body 100 of the guitar, as discussed below. Those skilled in the art will appreciate that various other methods for attaching the potentiometer 76 and 77 to the bridge body 11 are likewise suitable.

Knobs 73 and 74 attach to shafts 91 and 92 of the potentiometers 76 and 77, respectively. Knobs 73 and 74 may simply slide over the shafts 91 and 92 of the potentiometers 76 and 77 and be friction fit thereto according to well know principles. Alternatively, fasteners such as set screws, may be used to attach the knobs 73 and 74 to the shafts 91 and 92. Those skilled in the art will appreciate that various other means, such as adhesive bonding, for attaching the knobs 73 and 74 to the shafts 91 and 92 are likewise suitable.

The three saddle sections 21, 22 and 23 are received within their respective saddle grooves 12, 13 and 14. The piezoelectric sensors 31, 32 and 33 are similarly received within the saddle grooves 12, 13 and 14, such that the piezoelectric sensors 31, 32 and 33 are compressed between the saddle sections 21, 22, and 23 and the bridge body 11. The wires or electrical leads 34, 35, and 36 pass through the bores 16, 17, and 18 (FIG. 1) and into the body of the musical instrument, wherein the electrical leads 34, 35, and 36 facilitate electrical connection to a pre-amplifier, the tone and volume circuits, and/or any other desired electrical or electronic component or circuitry.

Referring now to FIG. 6, attachment of the potentiometers 76 and 77 to the guitar body 100 and the bridge body 11 is shown. The potentiometers 76 and 77 attach to the body 100 of the musical instrument and to the bridge body 11 by capturing the body 100 and the bridge body 11 between the potentiometers 76 and 77 and the attachment nuts 78 and 79. That is, the threaded shaft 83 and 84 of each potentiometer 76 and 77 is passed through contiguous openings 106 and 107 formed in the body 100 and contiguous openings 81 and 82 formed in the bridge body 11. The attachment nuts 78 and 79 are then threaded onto the posts 83 and 84 so as to secure the bridge body 11 to the body 100 and so as to secure the potentiometers 76 and 77 in place.

Although the potentiometers 76 and 77 attach the body 100 of the musical instrument to the bridge body 11 by capturing the body 100 and the bridge body 11 between the potentiometer 76 and 77 and the attachment nuts 78 and 79, such attachment preferably is not the primary structural attachment of the bridge body 11 to the body 100 of the musical instrument. Preferably, the bridge body 11 is adhesively bonded, such as via epoxy, to the body 100 of the musical instrument and preferably such adhesive bonding is the primary structural attachment of these items to one another.

After the attachment nuts 78 and 79 have been tightened, the knobs 73 and 74 are pushed onto the shafts 91 and 92 of the potentiometers 76 and 77, respectively.

As mentioned above, spacers or locknuts 111, 112 space the body of each potentiometer 76, 77 away from the body 100 of the guitar. In this manner, undesirable rattling or other noises caused by the body of the potentiometers 76, 77 touching the body 100 of the guitar are substantially mitigated and the acoustic characteristics of the musical instrument are enhanced.

Referring now to FIG. 7, a neck 101 is attached to the body 100 to define an electrical musical instrument. The bridge assembly 10 is positioned upon the body 100 of the guitar at a location which provides proper intonation.

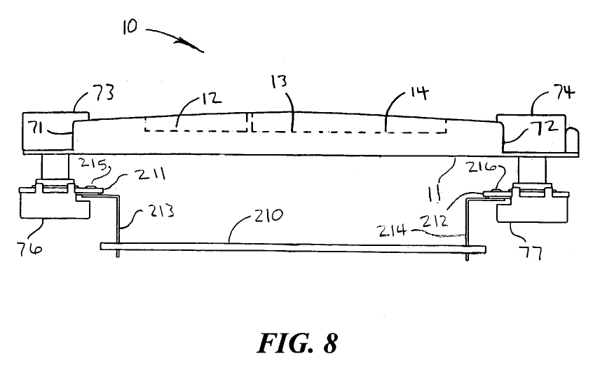

Referrin now to FIG. 8, a printed circuit board 210 may optionally be attached to the bridge assembly 10. Preferably, the printed circuit board 210 is attached to the bridge assembly 10 via metal, preferably copper or aluminum, conductive brackets 213 and 214 which function both to facilitate mechanical mounting of the printed circuit board to the bridge assembly 10 and to facilitate electrical communication between the potentiometers 76 and 77 and the printed circuit board 210. Thus, the conductive brackets 213 and 214 may be attached to the terminals 211 and 212 of the potentiometers via rivets or solder 215 and 216.

The circuit board 210 may contain any desired circuitry, such as circuitry associated with the tone and volume controls. For example, the printed circuit board may contain either active or passive circuitry for modifying the sound of the signals provided by the pickups. Thus, the printed circuit board 210 may contain amplification, attenuation, tone, digital signal processing (DSP) or any other desired circuitry. Further, the printed circuit board may provide a set of terminal for facilitating the simple and convenient attachment of conductors between the tone and volume controls and any other desired circuitry, such as the guitar cord phono jack, tone and volume circuitry, amplifiers, attenuators and any other circuitry not on the printed circuit board 210.

Attachment of the printed circuit board 210 to the bridge assembly 10 provides a reduced vibration mounting of the printed circuit board 210, reduces the length of the cables of the piezoelectric sensors (which tends to enhance their performance), and reduces the length of the oulet cable from the printed circuit board 210 to the cable output jack of the quitar.

It is understood that the exemplary bridge assembly for an electric musical instrument described herein and shown in the drawings represents only a presently preferred embodiment of the invention. Indeed, various modifications and additions may be made to such embodiment without departing from the spirit and scope of the invention. For example, various different shapes or footprints of the bridge assembly are contemplated. Thus, the bridge assembly may alternatively be generally rectangular, oval, or of any other desired general shape. Additionally, the strings need not be terminated at the bridge assembly itself but rather may alternatively be terminated via a tail piece or other termination structure. Additionally, any desired number of saddles may be utilized. Additionally, any desire number of controls maybe formed to the bridge for controlling any desired number of electrical parameters. Thus, one, two, three, four, or more electrical controls may be formed to the bridge. The electrical controls formed to the bridge are not limited to electrical controls utilizing rotary switches. Rather, any desire type of switch, including selector switches, push button switches, slide switches and any other type of switch, may be used either alone or in combination with one another, according to the present invention. Thus, these and other modifications and additions may be obvious to those skilled in the art and may be implemented to adapt the present invention for use in a variety of different applications.

What is claimed is:

1. A bridge assembly for a instrument, the bridge assembly comprising:
a bridge body; and
at least one electrical control formed to the bridge body for controlling at least one electrical parameter of the musical instrument.

2. The bridge assembly as recited in claim 1, wherein the bridge body is configured for use with at least one of an electric guitar, an acoustic-electric guitar, and a semi-acoustic guitar.

3. The bridge assembly as recited in claim 1, wherein the electrical control(s) comprise two electrical controls.

4. The bridge assembly as recited in claim 1, wherein each electrical control is disposed proximate an end of the bridge body.

5. The bridge assembly as recited in claim 1, wherein the electrical control(s) comprise at least one rotary switch.

6. The bridge assembly as recited in claim 1, wherein the electrical control(s) comprise two rotary switches.

7. The bridge assembly as recited in claim 1, wherein the electrical control(s) comprise at least one potentiometer.

8. The bridge assembly as recited in claim 1, wherein the electrical control(s) comprise two potentiometers.

9. The bridge assembly as recited in claim 1, wherein at least one of the electrical controls comprises:
a potentiometer; and
knob formed to the potentiometer.

10. The bridge assembly as recited in claim 1, wherein the electrical control(s) comprise:
a tone control; and
a volume control.

11. The bridge assembly as recited in claim 1, wherein:
the bridge body comprises at least one recess; and
as least one of the electrical control(s) comprises a knob disposed within the recess(es).

12. The bridge assembly as recited in claim 1, wherein:
the bridge body comprises at least one recess; and
as least one of the electrical control(s) comprises a knob disposed within the recess(es) such that a top of the knob extends above the bridge body.

13. The bridge assembly as recited in claim 1, wherein:
the bridge body comprises at least one recess; and
as least one of the electrical control(s) comprises a knob disposed within the recess(es) such that a portion of a side of the knob extends out of the recess.

14. The bridge assembly as recited in claim 1, wherein:
the bridge body comprises at least one recess; and
as least one of the electrical control(s) comprises a knob disposed within the recess(es) such that a top of the knob extends above the bridge body and such that a portion of a side of the knob extends out of the recess.

15. The bridge assembly as recited in claim 1, wherein the bridge body is configured to facilitate intonation compensation adjustment for at least one string.

16. The bridge assembly as recited in claim 1, wherein the bridge body is configured to facilitate intonation compensation for six strings.

17. The bridge assembly as recited in claim 1, further comprising three saddle sections, each saddle section being configured to support two strings.

18. The bridge assembly as recited in claim 1, further comprising:
three saddle sections, each saddle section being configured to support two strings; and
three vibration sensors, one vibration sensor being disposed beneath each saddle section.

19. The bridge assembly as recited in claim 1, further comprising:
three saddle sections, each saddle section being configured to support two strings; and
three piezoelectric vibration sensors, one piezoelectric vibration sensor being disposed beneath each saddle section.

20. A bridge assembly comprising:
three saddle sections, each saddle section being configured to support two strings; and
three vibration sensors, one vibration sensor being disposed beneath each saddle section.

21. A musical instrument, the musical instrument comprising:
a neck;
a body attached to the neck;
a bridge assembly formed upon the body, the bridge assembly comprising:
a bridge body; and
at least one electrical control formed to the bridge body for controlling at least one electrical parameter of the musical instrument.

22. The musical instrument as recited in claim 21, wherein the bridge body is configured for use with an electric guitar.

23. The musical instrument as recited in claim 21, wherein the electrical control(s) comprise two electrical controls.

24. The musical instrument as recited in claim 21, wherein each electrical control is disposed proximate an end of the bridge body.

25. The musical instrument as recited in claim 21, wherein the electrical control(s) comprise at least one rotary switch.

26. The musical instrument as recited in claim 21, wherein the electrical control(s) comprise two rotary switches.

27. The musical instrument as recited in claim 21, wherein the electrical control(s) comprise at least one potentiometer.

28. The musical instrument as recited in claim 21, wherein the electrical control(s) comprise two potentiometers.

29. The musical instrument as recited in claim 21, wherein the electrical control(s) comprise:
a tone control; and
a volume control.

30. The musical instrument as recited in claim 21, wherein the bridge body is configured to facilitate intonation compensation for at least one string.

31. The musical instrument as recited in claim 21, wherein the bridge body is configured to facilitate intonation compensation for six strings.

32. A guitar comprising:
a neck;
a guitar body attached to the neck;
a bridge assembly formed upon the guitar body, the bridge assembly comprising:
a bridge body;
a tone control formed at one end of the bridge body; and
a volume control formed at an other end of the bridge body.

33. A method for making a bridge assembly for a musical instrument, method comprising:
providing a bridge body; and
forming at least one electrical control to the bridge body, the electrical control suitable for controlling at least one electrical parameter of the musical instrument.

34. The method as recited in claim 33, wherein the bridge body is configured for use with at least one of an electric guitar, an acoustic-electric guitar, and a semi-acoustic guitar.

35. The method as recited in claim 33, wherein the electrical control(s) comprise two electrical controls.

36. The method as recited in claim 33, wherein each electrical control is disposed proximate an end of the bridge body.

37. The method as recited in claim 33, wherein the electrical control(s) comprise at least one rotary switch.

38. The method as recited in claim 33, wherein the electrical control(s) comprise two rotary switches.

39. The method as recited in claim 33, wherein the electrical control(s) comprise at least one potentiometer.

40. The method as recited in claim 33, wherein the electrical control(s) comprise two potentiometers.

41. The method as recited in claim 33, wherein the electrical control(s) comprise:
a tone control; and
a volume control.

42. The method as recited in claim 33, wherein the bridge body is configured to facilitate intonation compensation for at least one string.

43. The method as recited in claim 33, wherein the bridge body is configured to facilitate intonation compensation for six strings.

44. A method for making a musical instrument, the method comprising:
providing a neck;
attaching a musical instrument body to the neck;
forming a bridge assembly upon the musical instrument body, the bridge assembly comprising:
a bridge body; and
at least one electrical control formed to the bridge body for controlling at least one electrical parameter of the musical instrument.

45. The method as recited in claim 44, wherein the bridge body is configured for use with at least one of an electric guitar, an acoustic-electric guitar, and a semi-acoustic guitar.

46. The method as recited in claim 44, wherein the electrical control(s) comprise two electrical controls.

47. The method as recited in claim 44, wherein each electrical control is disposed proximate an end of the bridge body.

48. The method as recited in claim 44, wherein the electrical control(s) comprise at least one rotary switch.

49. The method as recited in claim 44, wherein the electrical control(s) comprise two rotary switches.

50. The method as recited in claim 44, wherein the electrical control(s) comprise at least one potentiometer.

51. The method as recited in claim 44, wherein the electrical control(s) comprise two potentiometers.

52. The method as recited in claim 44, wherein the electrical control(s) comprise:
a tone control; and
a volume control.

53. The method as recited in claim 44, wherein the bridge is configured to facilitate intonation compensation for at least one string.

54. The method as recited in claim 44, wherein the bridge is configured to facilitate intonation compensation for six strings.

55. A method for adjusting an electrical parameter of a guitar, the method comprising:
rotating a potentiometer formed at one end of a bridge of the guitar.

56. The method as recited in claim 55, wherein rotating a potentiometer comprises rotating a tone control.

57. The method as recited in claim 55, wherein rotating a potentiometer comprises rotating a volume control.

58. A method for converting vibration of a musical instrument into electrical signals representative of the vibration, the method comprising:
supporting adjacent pairs of strings via a saddle; and
converting vibration into electrical signals via a sensor disposed beneath the saddle(s).

59. A bridge assembly for a musical instrument, the bridge assembly comprising:
a bridge body;
at least one electrical control formed to the bridge body for controlling at least one electrical parameter of the musical instrument; and
a printed circuit board attached to the control(s).

60. The bridge assembly as recited in claim 59, wherein the electrical controls comprise potentiometers and wherein the printed circuit board is attached to the potentiometers via terminals of the potentiometers.

61. A method for making a bridge assembly for a musical instrument, method comprising:
providing a bridge body;
forming at least one electrical control to the bridge body, the electrical control suitable for controlling at least one electrical parameter of the musical instrument; and
forming at least one printed circuit board to at least one of the electrical controls.

62. The method for making a bridge body as recited in claim 61, wherein one printed circuit board is attached to two potentiometers via terminals of the potentiometers.
